(19) United States
(12) Patent Application Publication
(10) Pub. No.: US 2013/0284932 A1
(43) Pub. Date: Oct. 31, 2013

(54) FLAT LENS WITH MULTIPLE FOCAL LENGTHS AND A PASSIVE INFRARED SENSOR DEVICE WITH THE SAME

(71) Applicant: WEN-I HUANG, TAOYUAN COUNTY (TW)

(72) Inventor: WEN-I HUANG, TAOYUAN COUNTY (TW)

(73) Assignee: IR-TEC INTERNATIONAL LTD., TAOYUAN COUNTY (TW)

(21) Appl. No.: 13/457,648

(22) Filed: Apr. 27, 2012

(51) Int. Cl. G01J 5/08; G02B 3/10

(52) U.S. Cl. 250/353; 359/721

(57) ABSTRACT

A flat lens with multiple focal lengths has a lens segment. The lens segment is flat and has multiple convex lenses. The convex lenses are mounted on one of the surfaces of the lens segment, and have multiple focal lengths. With the different focal lengths of the convex lenses, multiple distances of detection of a sensor behind the lens segment can be extended to different lengths, and further increase the range of detection. Besides, with different distances of detection, the accuracy of detection would be enhanced effectively, and the erroneous estimate on a volume of the object would reduce effectively. Furthermore, because a shape of the lens segment is flat, the lens as described is more innovative and aesthetically appealing, and is relatively easier to match the building's design or decoration.

### BACKGROUND OF THE INVENTION

1. Field of the Invention

The present invention relates to a flat lens with multiple focal lengths, especially to a flat lens that can increase the range and enhance the performance of sensor detection, and is more aesthetically appealing with its low profile appearance.

2. Description of the Prior Arts

Sensor device is usually used to detect human movements and provides signals to an automatic sensor switch for various applications. For example, the sensor device can be combined with a light to provide occupancy sensing control. When the sensor device detects any human in presence, it turns on the light automatically. After the person leaves the range of detection of the sensor device, the light turns off automatically to save. Therefore, the user can turn on or off the light without touching anything.

With reference to FIG. 5, the conventional sensor device comprises a sensor 91 and a lens 92. The lens 92 is half-spherical and covers the sensor 91. For increasing the range and the distance of detection of the sensor 91, the lens 92 has multiple convex lenses 921 mounted on an inside surface of the lens 92 so that the sensor 91 can detect farther through the convex lens 921.

However, because the focal lengths of the convex lenses 921 are the same, the extensions of the distance of detection through the convex lenses 921 are the same as well. As a result, the detection range cannot be increased effectively. If the object is too close to or too far away from the sensor 91 and is not in the exact extended distance, the sensor 91 would have an erroneous estimate on the volume of the object. Therefore, the sensor 91 may regard a kitty, puppy or even mouse as a human, and turns on the light therefore.

Besides, the protruding shape of the half-spherical lens 92 sometimes cannot meet the requirement of interior decorator. Especially when the sensor device is installed in a flat surface, the protruding of the lens 92 can be unfavorable.

To overcome the shortcomings, the present invention provides a flat lens with multiple focal lengths to mitigate or obviate the aforementioned problems.

### SUMMARY OF THE INVENTION

The main objective of the present invention is to provide a flat lens with multiple focal lengths that can increase the range and enhance the performance of sensor detection, and is more aesthetically appealing with its low profile appearance.

The flat lens with multiple focal lengths in accordance with the present invention has a lens segment. The lens segment is flat and has multiple convex lenses. The convex lenses are mounted on one of the surfaces of the lens segment, and have multiple focal lengths. With the different focal lengths of the convex lenses, multiple distances of detection of a sensor behind the lens segment can be extended to different lengths, and further increase the range of detection. Besides, with different distances of detection, the accuracy of detection would be enhanced effectively, and the erroneous estimate on a volume of the object would reduce effectively. Furthermore, because a shape of the lens segment is flat, the lens as described is more innovative and aesthetically appealing, and is relatively easier to match the building's design or decoration. Other objectives, advantages and novel features of the invention will become more apparent from the following detailed description when taken in conjunction with the accompanying drawings.

### BRIEF DESCRIPTION OF THE DRAWINGS

FIG. 1 is a bottom perspective view of a first embodiment of a flat lens with multiple focal lengths in accordance with the present invention;

FIG. 2 is a top perspective view of the flat lens with multiple focal lengths in FIG. 1;

FIG. 3 is a side view in partial section of the flat lens with multiple focal lengths in FIG. 1;

FIG. 4 is a bottom perspective view of a second embodiment of a flat lens with multiple focal lengths in accordance with the present invention; and

FIG. 5 is a side view in partial section of a conventional lens in accordance with the prior art.

### DETAILED DESCRIPTION OF THE PREFERRED EMBODIMENTS

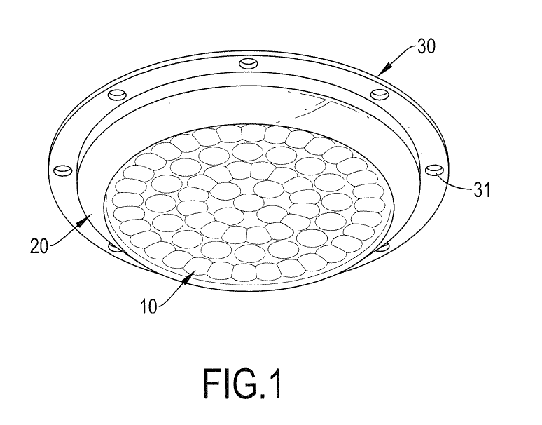

With reference to FIG. 1, a flat lens with multiple focal lengths in accordance with the present invention comprises a lens segment 10. In a preferred embodiment, the present invention further has a surrounding segment 20 and a mounting segment 30.

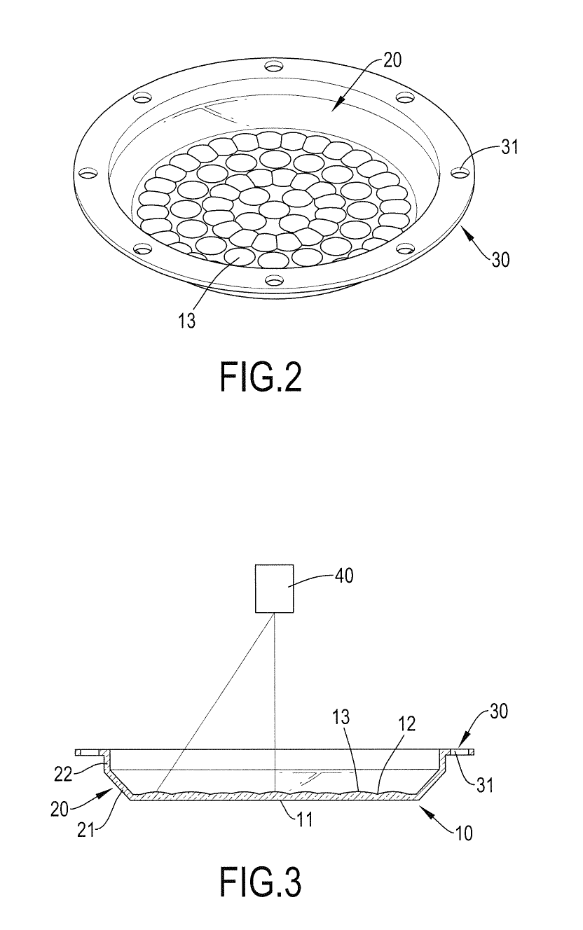

With reference to FIGS. 1 to 3, the lens segment 10 is flat and transparent, and has an inside surface 12, an outside surface 11 and multiple convex lenses 13. The convex lenses 13 are mounted on one of the surfaces 11, 12. Each convex lens 13 has its focal length. The convex lenses 13 have at least two different focal lengths. In a preferred embodiment, an outline of the lens segment 10 is circular. The convex lenses 13 are mounted on the inside surface 12. One of the convex lenses 13 is mounted on the middle of the inside surface 12, the other convex lenses 13 are arranged to form multiple homocentric circles, and each circle has multiple convex lenses 13 annularly arranged.

The surrounding segment 20 is formed annularly around a periphery of the lens segment 10. The surrounding segment 20 and the inside surface 12 of the lens segment 10 form an inner cavity. The surrounding segment 20 has a slope part 21 and a straight part 22. The slope part 21 is formed obliquely and outwardly on the periphery of the lens segment 10, and the straight part 22 is formed axially on the slope part 21.

The mounting segment 30 is transversely formed annularly around a periphery of the straight part 22 of the surrounding segment 20. The mounting segment 30 has multiple mounting holes 31 formed through the mounting segment 30.

With reference to FIG. 3, an infrared sensor device in accordance with the present invention comprises a sensor 40 and a flat lens with multiple focal lengths as described. The flat lens with multiple focal lengths covers the sensor 40.

When the lens as described is installed, the mounting segment 30 is welded to the sensor 40 or other part of the infrared sensor device by ultrasonic welding. In another preferred embodiment, the infrared sensor device has multiple circular prisms. The circular prisms are respectively mounted through the mounting holes 31 of the mounting segment 30, and then are welded to the mounting segment 30 by ultrasonic welding. Because a shape of the lens segment 10 is flat, the lens as described is more innovative and aesthetically appealing, and is relatively easier to match the building's design or decoration. Besides, with the different focal lengths of the convex lenses 13, multiple distances of detection of a sensor 40 behind the lens segment 10 can be extended to different lengths, and further increase the range of detection. Furthermore, with different distances of detection, the accuracy of detection would be enhanced effectively, and the erroneous estimate on a volume of the object would reduce effectively.

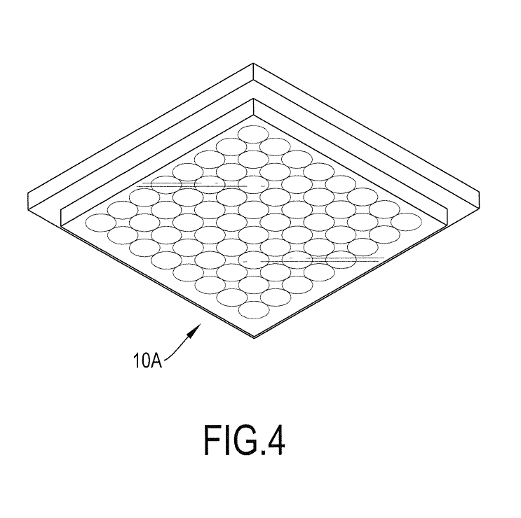

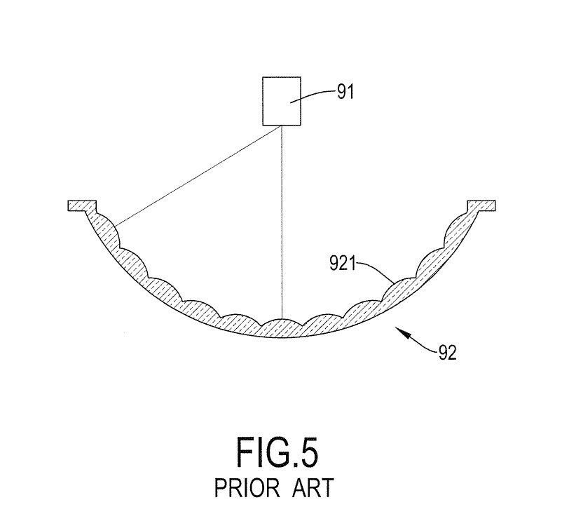

In another preferred embodiment as shown in FIG. 4, an outline of the lens segment 10A is rectangular.

In another preferred embodiment, the convex lenses also can be arranged in another way, such as being arranged radially.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A flat lens with multiple focal lengths comprising:
a lens segment being flat and transparent, and having:
an inside surface;
an outside surface; and
multiple convex lenses mounted on one of the surfaces, each convex lens having its focal length, and all the convex lens having at least two different focal lengths.

2. The flat lens with multiple focal lengths as claimed in claim 1, wherein the convex lenses are mounted on the inside surface.

3. The flat lens with multiple focal lengths as claimed in claim 1, wherein an outline of the lens segment is circular.

4. The flat lens with multiple focal lengths as claimed in claim 2, wherein an outline of the lens segment is circular.

5. The flat lens with multiple focal lengths as claimed in claim 1, wherein an outline of the lens segment is rectangular.

6. The flat lens with multiple focal lengths as claimed in claim 2, wherein an outline of the lens segment is rectangular.

7. The flat lens with multiple focal lengths as claimed in claim 1, wherein one of the convex lenses is mounted on the middle of the inside surface, the other convex lenses are arranged to form multiple homocentric circles, and each circle has multiple convex lenses annularly arranged.

8. The flat lens with multiple focal lengths as claimed in claim 4, wherein one of the convex lenses is mounted on the middle of the inside surface, the other convex lenses are arranged to form multiple homocentric circles, and each circle has multiple convex lenses annularly arranged.

9. The flat lens with multiple focal lengths as claimed in claim 1 further comprising a surrounding segment, wherein the surrounding segment is formed annularly around a periphery of the lens segment, and the surrounding segment and the inside surface of the lens segment form an inner cavity.

10. The flat lens with multiple focal lengths as claimed in claim 8 further comprising a surrounding segment, wherein the surrounding segment is formed annularly around a periphery of the lens segment, and the surrounding segment and the inside surface of the lens segment form an inner cavity.

11. The flat lens with multiple focal lengths as claimed in claim 9, wherein the surrounding segment has a slope part and a straight part, the slope part is formed obliquely and outwardly on the periphery of the lens segment, and the straight part is formed axially on the slope part.

12. The flat lens with multiple focal lengths as claimed in claim 10, wherein the surrounding segment has a slope part and a straight part, the slope part is formed obliquely and outwardly on the periphery of the lens segment, and the straight part is formed axially on the slope part.

13. The flat lens with multiple focal lengths as claimed in claim 1 further comprising a mounting segment, wherein the mounting segment is transversely formed annularly around a periphery of the lens segment.

14. The flat lens with multiple focal lengths as claimed in claim 12 further comprising a mounting segment, wherein the mounting segment is transversely formed annularly around a periphery of the straight part of the surrounding segment.

15. The flat lens with multiple focal lengths as claimed in claim 13, wherein the mounting segment has multiple mounting holes formed through the mounting segment.

16. The flat lens with multiple focal lengths as claimed in claim 14, wherein the mounting segment has multiple mounting holes formed through the mounting segment.

17. A passive infrared sensor device with a flat lens with multiple focal lengths as claimed in claim 1 comprising a sensor, wherein the flat lens with multiple focal lengths covers the sensor.
